(19) United States
(12) Patent Application Publication
(10) Pub. No.: US 2012/0064493 A1
(43) Pub. Date: Mar. 15, 2012

(54) METHOD FOR COGNITIVE COMPUTING

(75) Inventors: Newton Howard, Arlington, VA (US); Mathieu Guidere, Arlington, VA (US)

(73) Assignee: MAKE A MIND CORP., Cambridge, MA (US)

(21) Appl. No.: 13/083,352

(22) Filed: Apr. 8, 2011

Related U.S. Application Data
(60) Provisional application No. 61/322,158, filed on Apr. 8, 2010.

(51) Int. Cl. G09B 19/00

(52) U.S. Cl. 434/236

(57) ABSTRACT

The model treats individual expression in terms of negative or positive reflection of the state of mind on the world, and captures the full range of moods and cognitive states by computationally modeling the notions of ‘mind axiology’ and ‘emotional state’.

### CROSS-REFERENCE TO RELATED APPLICATIONS

This application claims priority under 35 U.S.C. §119 to U.S. Provisional Patent Application No. 61/322,158, filed Apr. 8, 2010, which is incorporated by reference in its entirety herein.

### FIELD OF THE INVENTION

The present invention relates to devices, methods and systems that enable advanced machine-machine interfaces, human-machine interfaces and applications that use such advanced interfaces.

### BACKGROUND OF THE INVENTION

Predictive linguistics is a new approach which changes the fundamental paradigm of cognition by introducing the time factor within the expression of the internal (psychological) and external (physical) world. It is a rapidly emerging field of linguistics that tries to explain the mental processes that underlie the human speech and writing in order to predict states of mind and states of cognition.

Classic approaches to understanding discourse have tended to explain the world in terms of truth-conditions. According to these traditional theories, the meaning of a particular sentence may be understood as the conditions under which the proposition conveyed by the sentence hold true. For instance, the expression “the book is open” is true if and only if the book is, in fact, open. Meanwhile, cognitive theories proved that meaning is conceptual. That is, meaning is not necessarily reference to the entity or relation in some real world. Instead, meaning corresponds with a concept held in the mind which is based on personal understanding of its value.

Predictive linguistics is characterized by adherence to three central positions. First, it claims that the only access which we have to the language of thought and to the psyche is via the languages (Kamp & Reyle, 1993). Second, it deals with language in terms of the conceptions, perceptions and intentions, sometimes universal, sometimes specific to a particular tongue or individual (Howard & Guidere, 2006). Third, it claims that we can know the future state of mind or state of cognition based on an in-depth analysis of language use in the present (Guidere, 2009). This makes the predictive linguistics proactive instead of being simply descriptive and enables advanced applications to be developed.

### SUMMARY OF THE INVENTION

The proposed model treats individual expression in terms of negative or positive reflection of the state of mind on the world, and captures the full range of moods and cognitive states by computationally modeling the notions of ‘mind axiology’ and ‘emotional state’.

The model measures observable phenomena that is emotional expression and gives a numerical estimation to feeling expression according to one quantity relative to another, and presents the operations by which it may meet the necessary criteria for objective measurement.

Within the proposed model, cognitive states are explained in terms of their relation to their expression in the common sense, not just in the terms of “true” versus “not true”. In other words, they are explained in terms of “axiology”, that is any state of mind that can only be understood and predicted if a larger system of expression is also understood.

The proposed model enables creating applications in a wide variety of areas, including but not limited to fields traditionally practiced by people rather than machines, such as psychology and neurology.

The proposed model enables new applications for human-machine interfaces, allowing machines to better understand humans and human emotions. It also enables machines to better mimic emotional responses, and develop personalities that can project an emotional state as well as be receptive to others' emotional states.

The proposed model is able to measure and explain a wide range of psychological phenomena than we would not be able to with the existing automated assessment tools. A preferred embodiment can be used to detect depression, but the model can be applied to a wide variety of emotional states and conditions.

According to one embodiment, a user enters a sentence or phrase into a computer system. The computer system assigns a value to each word based on various computational criteria. According to one aspect of the invention, the words are assigned either a positive or negative value. The value may also be assigned according to a database of words. The total value is calculated to determine a mind state indicator.

### BRIEF DESCRIPTION OF THE DRAWINGS

Further features and advantages of the invention can be ascertained from the following detailed description that is provided in connection with the drawing(s) described below:

FIG. 1 presents a flow-graph of the Mind State Indicator (MSI) algorithm for detecting depression and highlights the process of evaluating the mind state of an interlocutor, and determining if the interlocutor's mind state can be qualified as depressive.

FIG. 2 presents a flow-graph of the MSI algorithm augmentation.

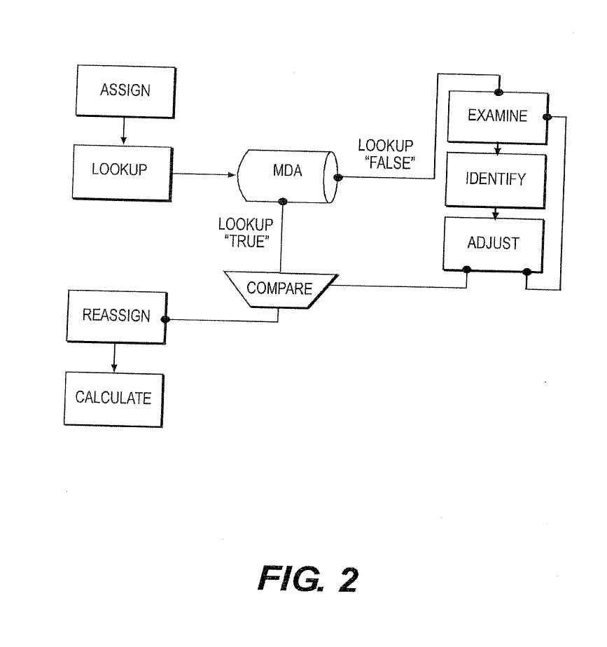

FIG. 3 is an exemplary block diagram of a computer system in which the present invention may be implemented.

### DETAILED DESCRIPTION OF THE INVENTION

Axiology. Axiologies are a central concept in the proposed model. Axiology (from Greek, axia, “value, worth”) is the study of quality or value. Axiology contains information about what concepts and expressions are “positive” and what expressions are “negative”, and how their “positivity” or “negativity” is related to one another.

Within the proposed model, cognitive states are explained in terms of their relation to their expression in the common sense, not just in the terms of “true” versus “not true”.

The system is centered around the concept of “value”, which is assigned to concepts and their combinations, and is made up of cultural attitudes, expectations, and background assumptions, as part of language and emotional meaning.

The proposed model maps words to feelings. A value is independent of the language structure or scenario and in effect it is an axiology that captures a portion of the existing world or the future state of mind. A word's value can enable identification of the world or the states that it represents.

The method is a distilled conceptual analysis of a patient's mood states and can correctly relate that to empirical data that has been accumulated. The analysis is based on four criteria, including: time-based analysis, intrinsic value, consequent value, and contextual value. The time-based analysis is dependent on time-orientation of the discourse whether the emphasis is in the past, present or future. Intrinsic value is dependent on the meaning of the word in itself or its semantic primes. Consequent value refers to words leading to something either good or bad (e.g., something is opposite to nothing). Contextual value is based on the identification of words that depend on other words and have a sense of linkage or belonging (e.g., my life).

The axiology is a formal representation of a set of concepts within a domain and the relationships between those concepts and their perceptions as expressed in language. It is used to reason about the properties of the cognitive state, and may be used to define the cognitive state. It provides a shared conceptualization, which can be used to model a cognitive state—that is, the type of state of mind and/or psyche that (may) exist, and their relations.

The axiology in the preferred embodiment is a software-encoded set of concepts and their assigned values (e.g., positive/negative), stored as a multi-dimensional network allowing lookup of concepts and their assigned values, in a variety of languages, and interpretable by a variety of parsers.

### Mind State Indicator (MSI)

A preferred embodiment is a device or a software program, such as a parser, capable of measuring cognitive states based on analyzing language use, and using axiology for lookup of concept values.

The mind state is represented as a sum value of the feelings expressed by the speaker's choice of words. In the “depression” cognitive state example, if the total sum of the values is >0, the speaker is labeled, at that moment, as “Positive” and as “Future-Oriented”. If the total sum is <0, the speaker is labeled “Negative” and “Retro-Oriented”. Other examples may have other designations for the cognitive states that are being detected.

The MSI algorithm starts from an initial state and proceeds through a well-defined series of successive states, but the transition from one state to the next is not necessarily deterministic and incorporates randomness:

1. Assume the first item is positive [+].

### 2. Check in the Mind Default Axiology [MDA].

3. Look at each of the remaining items in the list and if it is negative [−] as the next item so far, make a note of it as negative [−].
4. The last noted item is the positive [+] one in the list when the process is complete.

According to one embodiment, a sequence of IF-THEN-ELSE tests may comprise:

CASE 1: IF speaker is [I; We; Our; Ours] AND values' sum>0, THEN “Positive Ego-Centered Mind State (PECMS)”, ELSE
CASE 2: IF speaker is [He; She; They; You; Yours; Theirs, Me] AND values' sum>0, THEN “Positive Alter-Ego Mind State (PAEMS)” ELSE
CASE 3: IF speaker is [I; We; Our; Ours] AND values' sum<0, THEN “Negative Ego-Centered Mind State (NECMS)”, ELSE
CASE 4: IF speaker is [He; She; They; You; Yours; Theirs, Me] AND values' sum<0, THEN “Negative Alter-Ego Mind State (NAEMS)”, ELSE
CASE 5: IF speaker is NOT [I; We; Our; Ours; He; She; They; You; Yours; Theirs, Me], THEN “Negative Alter-Ego Mind State (NAEMS)”, EXIT.

According to another embodiment, the sequence of IF-THEN-ELSE tests may comprise:

TEST 1: IF speaker is NOT [I; We; Our; Ours], THEN display “Alter-Ego Mind State (AEMS), ELSE TEST 2:
TEST 2: IF speaker is NOT [He; She; They; You; Yours; Theirs, Me]
THEN display “Ego-Centered Mind State (ECMS)” ELSE TEST 3:
TEST 3: IF there is NO speaker, THEN display “Object-Centered Mind State (OCMS).

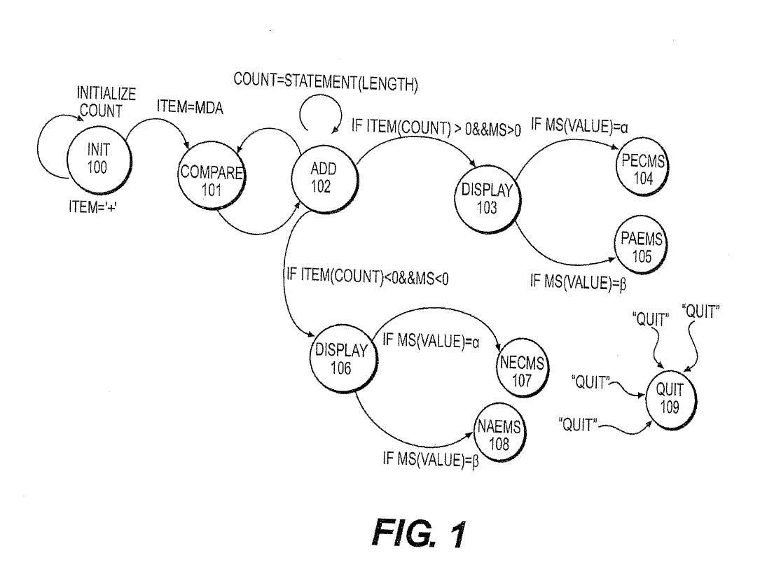

Referring to FIG. 1, the Mind State Indicator (MSI) algorithm starts from an initial state 100 in which the value of the first word item in a sentence is set to be positive (marked [+]) and the count is initialized. At the comparison state 101, the algorithm looks at each word in succession and compares it to the list of words in the MDA (Mind Default Axiology) while assigning the relative pre-set value to each one. This addition is repeated until the iteration traverses the whole sentence 102. The sum of these values is calculated; if the sum is positive and the mental state is positive, then the display can have two outputs 103. If the value of the mental state is α={I; We; Our; Ours} then the display is PECMS (Positive Ego-Centred Mind State) 104. If the value of the mental state is β={He; She; They; You; Yours; Theirs, Me} then the display is PAEMS (Positive Alter-Ego Mind State) 105. On the other hand, if the sum is negative and the mental state is negative then the display can have two outputs 106. If the value of the mental state is α={I; We; Our; Ours} then the display is NECMS (Negative Ego-Centred Mind State) 107. If the value of the mental state is β={He; She; They; You; Yours; Theirs, Me} then the display is NAEMS (Negative Alter-Ego Mind State) 108. All states will exit 109 after their values have been calculated and evaluated.

For example, the expression “She is complex and complicated yet interesting” is Negative because it can be rated [−1] based on an axiological evaluation of the expression. Note that the evaluation is applicable to expressions whatever their formal structure is:

“She [−] is [+] complex [−] and [+] complicated [−] yet [−] interesting [+]”→+3−4=−1
“She [−] is [+] complicated [−] yet [−] interesting [+]”→+3−4=−1
“She [−] is [+] complex [−] and [+] complicated [−]”→+2−3=−1
“She [−] is [+] complicated [−]”→+1−2=−1
“She [−] is [+] interesting [+]”→+2−1=+1

The following are additional examples of application of the Mind State Indicator (MSI) to authentic expressions labeled as Depression (MSI<0):

“I [+] can't [−] really [−] think [+] right [+] now [−]. I [+] need [−] to [−] post [+] why [−] I [+] am [−] here [−]. I [+] can't [−] figure [+] out [−] how [−] to [−] do [+] it [−]. So [+], please [−] be [−] patient [−] with [+] me [−].”→+11−17=−6 (MSI)
“I [+] realized [−] that [−] I'm [+] not [−] viewed [−] in [+] a [−] positive [+] way [−] at [+] my [+] husband's [+] coworkers [−]. I'm [+] ugly [−]. I [+] don't [−] look [−] like [−] a [−] woman [+]. I [+] look [−] like [−] a [−] man [−] to [−] them [−]. I [+] must [−] look [−] like [−] a [−] monster [−]. I [+] know [+] that [−] I'm [+] ugly [−].”→+15−25=−10 (MSI)
“I'm [+] embarrassed [−]. I [+] was [−] actually [−] happy [+] yesterday [−]. I [+] was [−] proud [+] of [−] myself [+] for [−] actually [−] caring [+] about [−] how [−] I [+] presented [−] myself [+] to [−] the [+] world [+]. Now [−] I [+] know [+]. I'm [+] a [−] fool [−]. I [+] bring [+] shame [−] to [−] my [+] husband [+] because [−] I'm [+] the [+] butt [−] of [−] the [+] office [+] “ugly [−] wife [−] jokes [−].” The [+] anxiety [−] is [+] making [+] me [−] so [+] sick [−]. I [+] can't [−] stop [−] shaking [−]. I [+] can't [−] stop [−] crying [−].”→+28−32=−4 (MSI)
“I'm [+] so [+] down [−] and [+] depressed [−] about [−] what [−] they [−] said [−] about [−] me [−]. I [+] can't [−] get [−] it [−] out [−] of [−] my [+] head [+]. I [+] feel [+] so [+] stupid [−]. I [+] feel [+] so [−] sick [−]. I [+] wish [−] I [+] could [−] just [−] walk [−] around [−] with [+] a [−] paper [+] bag [+] to [−] cover [−] my [+] head [+]. I [+] wish [−] I [+] could [−] just [−] become [−] invisible [−].”→+20−29=−9 (MSI)

The Mental State Indicator (MSI) clusters the data presented within the Mind Default Axiology (MDA). Although this database can have multiple dimensions, for simplicity, the output is represented along one axis. The mechanism can be augmented with a learning algorithm.

This process is characterized by a set of rules that are essential in identifying values associated with words, set of words correlated to concepts and an array of impressions signifying an individuals' expression or behavior. In the cases where the MDA lookup is unsuccessful, then words, phrases, and sentences may be examined individually and in groups for time-based orientation.

Once an analysis has been performed, value congruence plays a significant role in identifying the type of these values (e.g., consequent, contextual, frequent, culturally-dependent). The value can then be used to adjust the original assignment, depending on additional information about the patient. The algorithm will iteratively traverse the whole string of input and adjust accordingly until the index reached the end of the string. Once value estimation has been completed, a linear computation is performed to evaluate the final adjusted MSI value and accordingly project a patient's mood state.

According to one embodiment of the invention, a user enters a sentence, phrase, or expression into a computer system, which calculates the MSI. The entry may be done manually, e.g., with a keyboard, or with voice recognition software. However, a skilled artisan would be able to determine suitable methods of data entry.

### Computer System Architecture

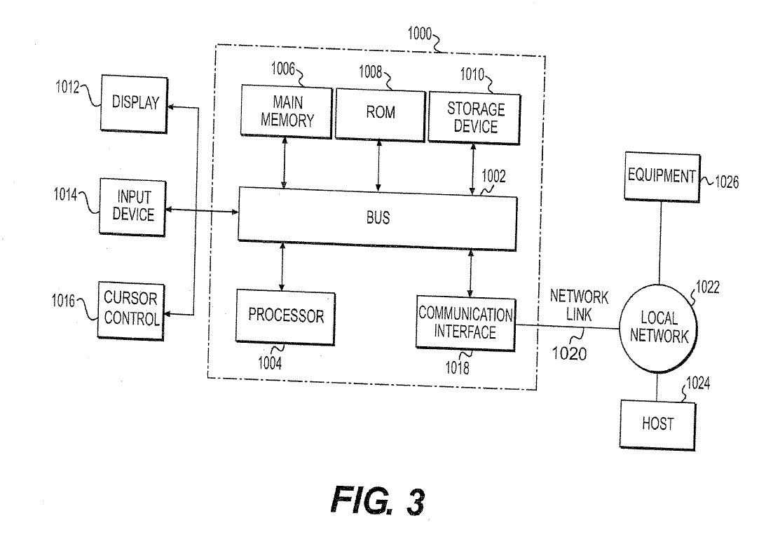

FIG. 3 is a block diagram illustrating an embodiment of a computer system 1000 that can be used to perform various functions described herein. In some embodiments, the computer system 1000 may be used to implement the method. In other embodiments, the computer system 1000 may be used to implement any of the components of the method. In further embodiments, the computer system 1000 may be used to implement a database.

Computer system 1000 includes a bus 1002 or other communication mechanism for communicating information, and a processor 1004 coupled with the bus 1002 for processing information. The computer system 1000 also includes a main memory 1006, such as a random access memory (RAM) or other dynamic storage device, coupled to the bus 1002 for storing information and instructions to be executed by the processor 1004. The main memory 1006 also may be used for storing temporary variables or other intermediate information during execution of instructions to be executed by the processor 1004. The computer system 1000 further includes a read only memory (ROM) 1008 or other static storage device coupled to the bus 1002 for storing static information and instructions for the processor 1004. A data storage device 1010, such as a magnetic disk or optical disk, is provided and coupled to the bus 1002 for storing information and instructions.

The computer system 1000 may be coupled via the bus 1002 to a display 1012, such as a cathode ray tube (CRT), for displaying information to a user. An input device 1014, including alphanumeric and other keys, is coupled to the bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. The display 1012, input device 1014, and the cursor control 1016 may be used to implement various user interfaces described herein.

In some embodiments, the computer system 1000 can be used to perform various functions described herein. According to some embodiments of the invention, such use is provided by computer system 1000 in response to processor 1004 executing one or more sequences of one or more instructions contained in the main memory 1006. Those skilled in the art will know how to prepare such instructions based on the functions and methods described herein. Such instructions may be read into the main memory 1006 from another computer-readable medium, such as storage device 1010. Execution of the sequences of instructions contained in the main memory 1006 causes the processor 1004 to perform the process steps described herein. One or more processors in a multi-processing arrangement may also be employed to execute the sequences of instructions contained in the main memory 1006. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1004 for execution. Such a medium may take many forms, including but not limited to, non-transitory and non-volatile media, volatile media, and transmission media. Non-volatile media includes, for example, optical or magnetic disks, such as the storage device 1010. Volatile media includes dynamic memory, such as the main memory 1006. Transmission media includes coaxial cables, copper wire and fiber optics, including the wires that comprise the bus 1002. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1004 for execution. For example, the instructions may initially be carried on a magnetic disk of a remote computer. The remote computer can load the instructions into its dynamic memory and send the instructions over a telephone line using a modem. A modem local to the computer system 1000 can receive the data on the telephone line and use an infrared transmitter to convert the data to an infrared signal. An infrared detector coupled to the bus 1002 can receive the data carried in the infrared signal and place the data on the bus 1002. The bus 1002 carries the data to the main memory 1006, from which the processor 1004 retrieves and executes the instructions. The instructions received by the main memory 1006 may optionally be stored on the storage device 1010 either before or after execution by the processor 1004.

The computer system 1000 also includes a communication interface 1018 coupled to the bus 1002. The communication interface 1018 provides a two-way data communication coupling to a network link 1020 that is connected to a local network 1022. For example, the communication interface 1018 may be an integrated services digital network (ISDN) card or a modem to provide a data communication connection to a corresponding type of telephone line. As another example, the communication interface 1018 may be a local area network (LAN) card to provide a data communication connection to a compatible LAN. Wireless links may also be implemented. In any such implementation, the communication interface 1018 sends and receives electrical, electromagnetic or optical signals that carry data streams representing various types of information.

The network link 1020 typically provides data communication through one or more networks to other devices. For example, the network link 1020 may provide a connection through local network 1022 to a host computer 1024 or to equipment/device 1026, or a switch operatively coupled to any of the devices described herein. The data streams transported over the network link 1020 can comprise electrical, electromagnetic or optical signals. The signals through the various networks and the signals on the network link 1020 and through the communication interface 1018, which carry data to and from the computer system 1000, are exemplary forms of carrier waves transporting the information. The computer system 1000 can send messages and receive data, including program code, through the network(s), the network link 1020, and the communication interface 1018.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include storage media, examples of which include, but are not limited to, floppy disks, hard disk drives, CD-ROMs, DVDROMs, RAM, and, flash memory, as well as transmission media, examples of which include, but are not limited to, digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of determining a mental state comprising:
entering words into a computer or similar device;
assigning a value to each word based on various computational criteria;
computing a mental state indicator based on the total value of the words.
